(19) United States
(12) Patent Application Publication
(10) Pub. No.: US 2016/0044472 A1
(43) Pub. Date: Feb. 11, 2016

(54) MOBILE ENTRY FOR HOTEL GUEST ROOMS

(71) Applicant: Todd J. Person, Frisco, TX (US)

(72) Inventor: Todd J. Person, Frisco, TX (US)

(21) Appl. No.: 14/454,705

(22) Filed: Aug. 7, 2014

(51) Int. Cl. H04W 4/14; G07C 9/00; H04W 4/00; H04L 29/06; G06Q 10/02; H04W 12/04

(52) U.S. Cl. CPC H04W 4/14; G06Q 10/02; H04W 12/04; H04W 4/008; H04L 63/062; G07C 9/00166

(57) ABSTRACT

The invention provides systems, methods and devices that allow a hotel guest room management system to manage the activation and opening of hotel locks, as well as for managing the data associated with those locks. When implemented as a software application (or “App(s)”), the Apps, typically proprietary to individual hotel companies or hotel management companies, use the invention implemented as a system and preferably enabled as a Software Development Kit (“SDK”).

### CROSS-REFERENCE TO RELATED APPLICATION

### Claim of Priority

Not applicable.

### STATEMENT REGARDING FEDERALLY SPONSORED RESEARCH OR DEVELOPMENT

Not applicable.

### FIELD OF THE INVENTION

This invention relates generally to applications for mobile devices, and more specifically to systems, methods and devices for enabling entry into hotel guest rooms.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Locks for commercial use, such as for hotel guest rooms, are evolving. Hotel guest room locks have an average life of approximately seven to ten years. Almost universally, hotel operators have transitioned out of the lock-and-key systems to a key-card system (the transition was defined by a shift to an electronic lock from a purely-mechanical, turn-key lock). Electronic locks work by reading magnetic strips attached to key cards. The lock looks for a specific code on the magnetic strip provided by the encoding device at the hotel's front desk. These codes are imprinted on to the magnetic strip of each key card. The front desk encoder also assigns date and time parameters under which the code will be active. When a hotel guest presents the card to the lock, within the appropriate date and time, and if the lock recognizes the code as being the correct code issued from the front desk, the door will unlock. Unlike the old system, if a key is lost or stolen, the lock does not have to be replaced to ensure security. The front desk simply issues a new code on a new key card. Once the new key card is created by the front desk, the lost or stolen key card will no longer work. This process requires the customer to come in, wait in line at the front desk, and wait for the card to be issued. The same process must be repeated for lost cards.

As hotels constantly try to cater more to the customer, offering a less tedious entry system has become increasingly important. Just as the traditional turn-key locks gave way to the more accessible, electronic magnetic strip locks, a new lock is gaining popularity for its ease of access. The new locks use Near Field Communications (NFC) systems such as Radio Frequency Identification (“RFID”) technology and/or Bluetooth technology (currently, version 4.0). The basic mechanism of the lock works the same but the mode of transmitting the code from the encoder to the card and the card to the lock takes a different form. Instead of imprinting the code on a magnetic strip, the code is printed on the key card wirelessly. Since the mode for transmitting the code to the lock reader is now wireless, customers no longer have to physically insert the key card into the lock. They only need to hold the card within a few inches of the lock for it to be recognized. This is helpful for guests carrying luggage, laptops, or other baggage to their hotel room. However, although the new locks have increased the ease of entry for the customer, the customer must still go through the front desk check-in process to get their key card.

This has resulted in a push to be able to access hotel room locks with mobile devices, allowing the customer to skip the front desk routine altogether. This has manifested itself in two ways. Many modern mobile devices are equipped with RFID or Bluetooth technologies, or more generally Near Field Communication (“NFC”) technologies. As a first example, phones with NFC technology can be used to communicate with the RFID-equipped encoders and the locks. This allows the phone to take the place of the RFID key card. Instead of the front desk issuing an RFID key card, an electronic “key” is sent wirelessly to the customer's mobile phone upon arrival to the hotel. Then, the phone can be held up to the lock just as the key card was. It will recognize the “key” via the NFC technology within the phone, and it will allow the guest to access the room if the code, time, and date parameters are all correct.

Second, locks can communicate with mobile devices via Bluetooth. Again, the fundamentals are the same but the medium is different. The lock is looking for the right code to allow access to the room. The front desk can wirelessly send this code to the customer's mobile phone with set date and time parameters. Each of the locks on the guest room doors is equipped with a Bluetooth Low Energy (“BTLE”) antenna. Phones that are compatible with BTLE can present the code they receive on their mobile device to the lock. The lock will receive the code information wirelessly, through the BTLE antenna, and unlock upon presentation of valid entry parameters.

Although the technology for locks using BTLE is not as developed as it is for RFID, once the lock infrastructure is in place, the potential exists for almost all hotel locks to transition to a mobile-accessible entry system (either RFID, Bluetooth, or other functionally equivalent technology), allowing the ultimate ease of consumer access. Accordingly, the need exists for an invention that facilitates the management of these wireless access systems.

### SUMMARY OF THE INVENTION

The current invention provides systems, methods and devices that allow a hotel management system to manage the opening of hotel locks, as well as the data associated with those locks. When implemented as one embodiment of a software application (or “App(s)”), these Apps, owned by hotel companies, use the invention implemented as a Software Development Kit (“SDK”) in order to power them. Accordingly, the invention provides an SDK that channels the information for supported lock companies into the hotel's App. When a customer books a reservation at one of the hotels, he or she can check in using that hotel's App. The invention provides the secure data medium that works behind the App to safely and securely deliver the electronic “key” through the interface of the App supplied by the hotel. Once the guest reaches their hotel room door, he or she opens the hotel's App. The invention provides the mechanism for sending the “key”, through the App, to the guest room lock. This transmission is handled safely and securely via the SDK.

### BRIEF DESCRIPTION OF THE DRAWINGS

Various aspects of the invention, as well as an embodiment, are better understood by reference to the following detailed description. To better understand the invention, the detailed description should be read in conjunction with the drawings and tables, in which:

FIG. 1 illustrates an exemplary hotel guest room management system.

FIG. 2 illustrates a Near Field Communication (NFC) lock algorithm.

FIG. 3 illustrates a simple Near Field Communication (NFC) lock algorithm.

### DETAILED DESCRIPTION OF THE DRAWINGS

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium, particularly control and detection/feedback methodologies. Computer-readable mediums include passive data storage, such as a random access memory (RAM) as well as semi-permanent data storage. In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to operate the methods of the invention. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise.

The numerous innovative teachings of present application are described with particular reference to presently preferred embodiments.

### Description of the Drawings

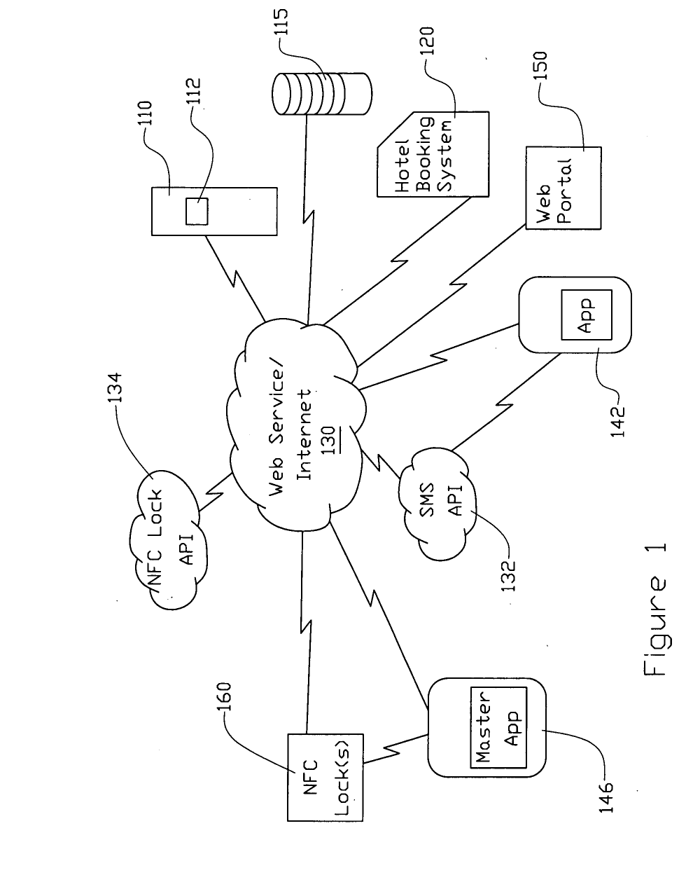

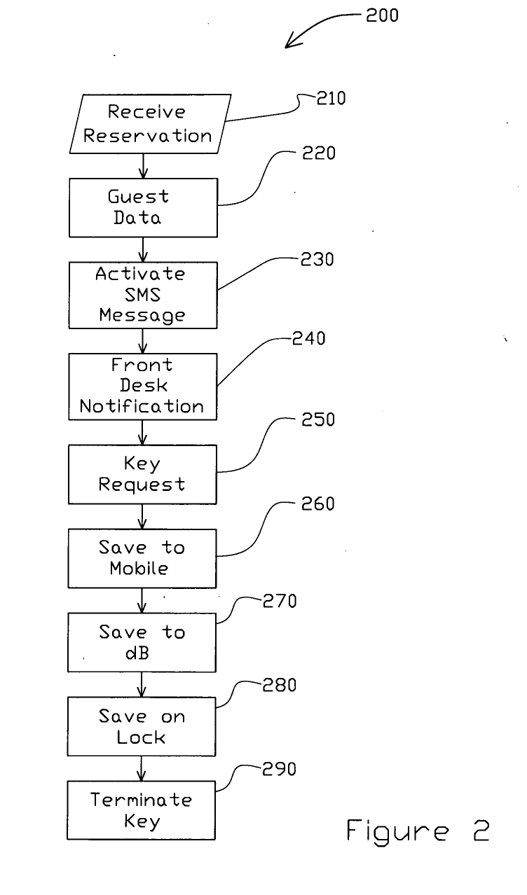

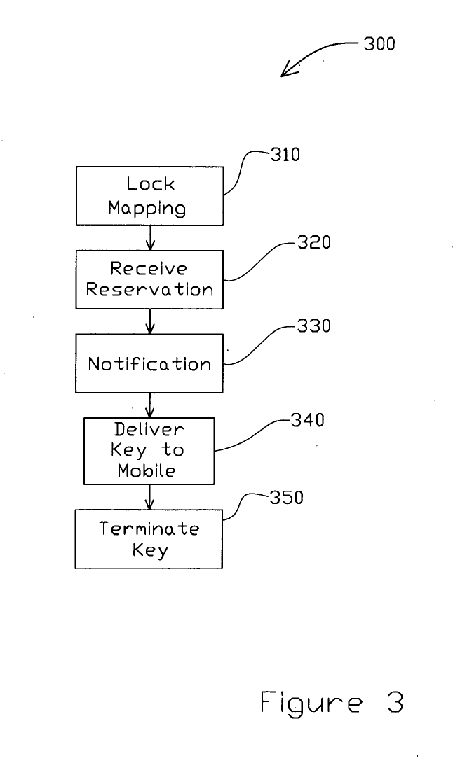

The disclosed preferred embodiment of the invention makes simultaneous reference to the drawings in which FIG. 1 illustrates an exemplary hotel guest room management system 100, FIG. 2 illustrates a Near Field Communication (NFC) lock algorithm 200, and FIG. 3 shows a flow chart of a simple NFC lock algorithm 300. In general, smart NFC locks may communicate directly to a web services network such that their digital key may be altered remotely, while simple NFC locks are not network connectable and require a near-field-enabled device, such as an Android Pad®, to be in near-field communication to set the digital key.

The hotel guest room management system 100 (“the system”) is for controlling Near Field Communication (NFC) locks. In general, the system 100 includes a first computing device 110 in communication with a web services network 130, and a database 115 in communication with the first computing device 110. The web services network 130 preferably includes the internet, and may also incorporate telephony networks and proprietary network elements. The database 115 may be a structured database, such as MySQL, or an unstructured database, such as Azure®, and in either case may reside in a cloud architecture.

The first computing device 110 includes a computer-readable storage medium 112, such as a flash-memory or hard-drive, that maintains at least one programming instruction that, when executed, causes the system to: receive a reservation for a hotel room from a hotel booking system 120 in a receive reservation act 210, store a first guest data set in the database 115 in a store data act 220, and to initiate the generation an SMS text message in an activate SMS message act 230. To generate the SMS message, the first computing device 110 sends a first instruction to a first application programming interface (API) 132 which is a short messaging service (SMS) API. The SMS API 132 initiates a first text message that is directed to a first mobile device 142 associated with the reservation. Preferably, the first text message includes a link to download the first App.

The first mobile device 142, as well as other mobile devices disclosed herein may be any of the portable computing devices that are connectable to a data or voice network, such as phones/pads/laptops and the like, regardless of operating system, and especially includes presently popular devices such as the various Apple® iPod/iPhone/iPads®, Android® devices (regardless of manufacturer), and Microsoft® devices (again, regardless of manufacturer), for example. In one embodiment, the first text message provides a user a choice to check into the reserved hotel room by using a mobile device check-in service; in addition, the first text message may provide the user a link to download the relevant mobile app for their device to utilize the mobile check-in option. If the user indicates that they wish to use the mobile check-in option, that choice is sent to a front desk web portal 150 via the web services network 130, preferably having a front desk App, in a front desk notification act 240.

A variety of data transfers may take place. For example, the database 115 may fetch room reservation data regarding the reserved room, typically from the database 115, or alternatively the first mobile device 142 or the hotel booking system 120 page itself.

In response to the notification of the scheduled mobile check-in, the front desk web portal 150 sends a key request through the web services network 130 to a second API 134 that is associated with the type of Near Field Communication (NFC) lock 160 used to lock the reserved hotel room. The NFC lock 160 preferably communicates via Bluetooth® or radio frequency identification (RFID), and accordingly either has a Bluetooth chip, an RFID tag, or both. Upon receipt of the request, a first digital key is generated, which is then sent to: A) the database 115 which stores and associates the first digital key with the reserved room in a save key act 270, and B) to the first mobile computing device in a send key to mobile act 270. In the event the NFC lock is a smart NFC lock, the digital key is also automatically wirelessly sent to and written on the NFC lock 160 in a send key to lock act 280.

The NFC lock algorithm 200 terminates the first digital key and ends in a terminate key act 290. Key termination may take place following a predetermined period of time, in response to an input received from the front desk web portal 150, or as a function of other scheduling logic (such as an approved late check-out). In a preferred embodiment, the first digital key is permanently deleted from the NFC lock 160.

The simple NFC lock algorithm 300 starts with a lock mapping act 310 in which a master App resides on a second mobile device 146 which is configured to communicate with the NFC lock. Here, preferably a first digital key is assigned via the master App.

In the lock mapping act 310, the master App receives a set of keys, which are then assigned, one or more at a time, to each individual NFC lock. Accordingly, the mater App resides on the second mobile computing device 146, and includes either a Bluetooth chip, an RFID tag, or both to enable near-field-communication with the simple NFC lock 160.

A hotel guest room reservation is received from the hotel booking system 120 in the receive reservation act 320. Then, in a notification act 330, the front desk web portal 150, and the master App on the second mobile device 146 are notified of the reservation. The code causes fetching of information relevant to the reservation, which may be a fetch from the database 115, from the first mobile computing device 142, or the hotel booking system 120, for example.

Next, in a deliver key to mobile act 340, the computing device 110 delivers at least a first digital key to the App of the first mobile device 142, preferably by a code sent as an SMS message to the first mobile computing device. Next, the simple NFC lock algorithm 200 terminates the first digital key and ends in a terminate key act 290, which may terminate as described above, or in any other manner known or foreseeable in the hotel NFC lock arts.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications

We claim:

1. A hotel guest room management system for controlling Near Field Communication (NFC) locks, comprising:
at least a first computing device in communication with a web services network;
a database in communication with the first computing device;
the first computing device includes a computer-readable storage medium, the computer-readable storage medium comprising at least one programming instruction that, when executed, causes the system to:
receive a reservation for a hotel room from a hotel booking system;
store a first guest data set in the database;
send a first instruction to a first application programming interface (API), the first API being a short messaging service (SMS) that initiates a first text message that is directed to a first mobile device, the first mobile computing device being associated with the reservation and being in communication with the web services network;
the first mobile computing device,
receives the first text message which provides a user the ability to choose to check into the reserved hotel room by using a mobile device check-in service; and
upon a user indication that a mobile device check-in service is selected, reporting that user-decision to the web services;
in response to the user indication of the selection of a mobile device check-in service on the first mobile device, a front desk App:
receives a notice of the selection of the mobile device check-in service at a front desk web portal; and
sends a key request through the web services network to a second API, the second API being associated with the type of near field communication lock used to lock the reserved hotel room;
a first digital key is generated by the second API;
the second API communicates, through the web services network, the first digital key to the first mobile computing device; and
terminating the first digital key.

2. The method of claim 1 wherein the first text message comprises a link to download the first App.

3. The method of claim 1 further comprising fetching room reservation data regarding the reserved room from the first mobile device.

4. The method of claim 1 further comprising the first mobile device fetching a room reservation data regarding the reserved room from the database.

5. The method of claim 1 wherein terminating the first digital key automatically occurs following a predetermined period of time.

6. The method of claim 1 wherein terminating the first digital key occurs in response to an input received from the front desk web portal.

7. The method of claim 1 wherein terminating the first digital key permanently deletes the first digital key from the near field communication lock.

8. The method of claim 1 wherein the near field communication lock comprises a Bluetooth chip.

9. The method of claim 1 wherein the near field communication lock comprises a radio frequency identification (RFID) tag.

10. The method of claim 1 wherein the near field communication lock is a smart lock in which the digital key may be changed remotely from the NFC lock.

11. The method of claim 1 wherein the computing device delivers at least a first digital key to a master App, the master App being configured to load at least the first digital key on a first NFC lock.

12. The method of claim 11 wherein the mater App resides on a second mobile computing device.

13. The method of claim 11 further comprising initiating via the front desk web portal, a code via an SMS message to the first mobile computing device, the code initiates fetching of information relevant to the reservation from the first mobile computing device.

14. The method of claim 1 wherein the database is an unstructured database.

15. The method of claim 1 wherein the database resides in a cloud architecture.

16. The method of claim 1 wherein the first digital key is assigned via a master App, the master App operating on a second mobile computing device, the second mobile computing device configured to communicate with the NFC lock.

17. The method of claim 1 wherein the second API communicates, through the web services network, the first digital key to the database which stores the first digital key and associates the first digital key with the reserved room.
